(19) United States
(12) Patent Application Publication
(10) Pub. No.: US 2004/0174267 A1
(43) Pub. Date: Sep. 9, 2004

(54) Toilet

(76) Inventor: Axel Benkhardt, Hamburg (DE)

Correspondence Address: FRIEDRICH KUEFFNER, 317 MADISON AVENUE, SUITE 910, NEW YORK, NY, 10017, US

(21) Appl. No.: 10/802,335

(22) Filed: Mar. 16, 2004

Related U.S. Application Data
(63) Continuation of application No. 10/160,351, filed on May 31, 2002.

(30) Foreign Application Priority Data
Aug. 14, 2000 (DE) 200 14 002.7

(51) Int. Cl. G08B 21/00

(52) U.S. Cl. 340/686.1; 340/573.1

(57) ABSTRACT

A toilet includes a toilet bowl with a toilet seat made of a swivellable seat panel and a swivellable toilet lid as well as a wall-hung urinal which can be closed by a lid. A casing with a device for emitting acoustical speech and/or music information is placed fixed or removable by a support to at least one of the movable parts of the toilet or of the wall-hung urinal externally or internally. The casing includes a programmable or preprogrammed speech and/or music module or a chip card containing the speech and/or music information with a microprocessor control. The device is connected with a mechanically or light-optically controlled on-off switch or a motion detector in such a way that, when lifting the toilet lid and/or the seat panel and/or the urinal bowl lid, the putting in and out of action of the speech and/or music module is released by the reproduction of the speech and/or music recording.

The invention refers to a toilet according to the preamble of claim 1.

### BACKGROUND OF THE INVENTION

It is often necessary in the private as well as in the public domain to indicate in the toilet rooms by plates or other signs to the toilets users and to remind them not to leave the toilets and the toilet rooms dirty, whereby in the private sphere a toilet user can often verbally remind other occupants to actuate the toilet flush after having used the toilet, to leave clean the toilet bowl and the toilet seat and to close the toilet lid. Written warnings are often ignored and verbal reminders are not always possible.

Thus, the aim of this invention is to create a possibility in rooms containing toilets with which toilet users are urged over acoustical speech signals during the actuation of movable toilet parts such as the toilet seat and/or the toilet lid to leave the toilet clean after having used it. Furthermore, advertising information, advertising spots, product indications and the like are to be imparted to the toilet users, the technical solution consisting in a device which is to be kept hygienically clean.

The aim is achieved according to the invention for a toilet of the above mentioned type with the characteristics indicated in claim 1.

### SUMMARY OF THE INVENTION

Accordingly, the invention consists for toilets configured in a manner known per se and for wall-hung urinals which can be closed by a lid in that a casing with a device for delivering acoustical speech and/or music information is placed fixed or detachable directly or by means of a support to at least one of the movable parts of the toilets externally or internally, the casing comprising a programmable or preprogrammed speech and/or music module with a speech and/or music recording or a chip card containing the speech and/or music information and a microprocessor control, whereby the device is connected with a mechanically or light-optically controlled on-off switch or a motion detector in such a way that, when lifting the toilet lid and/or the seat panel, the putting in and out of action of the speech module is released by the reproduction of the speech and/or music recording.

The speech module itself consists of a casing with a source of current, preferably with a battery, a loudspeaker or for recording and reproduction with a microphone/loudspeaker unit and with a mechanically controlled on-off switch or an on-off switch controlled by means of a light-optical cell so that, when actuating the toilet lid and/or the seat panel, the speech and/or music module is set into operation in such a way that the stored speech and/or music recording is reproduced acoustically and in a manner which cannot be overheard. The control of the on-off switch for the speech and/or music module can also be made over a motion detector, for example in form of a conductive moving body, such as for example a lever, which opens or closes the contact with its movement. A motion detector detects if the speech and/or music module to which it is fixed undergoes a physical acceleration. This is generally always the case when, for using the toilet, the toilet lid is opened and/or the seat is lifted, whereby when closing both toilet parts a control of the music and/or speech module can be carried out. Furthermore, other types of detectors are possible for the condition of use, like switches, which detect the charge of the toilet seat in order to obtain an indication for the movement.

The warnings for keeping clean the toilet, wall-hung urinals and toilet rooms which formerly were oral are now carried out over the toilet itself, whereby parts of the toilet such as the toilet lid or the bowl lid and/or the seat panel are pivoted, either when opening or when closing the lid. The use of a mechanical on-off switch for the speech and/or music module makes its starting possible when opening and closing the toilet seat parts, whereas when using non responsive elements the speech and/or music module can only be activated when the toilet lid, the urinal bowl lid and/or the seat panel is lifted so that light falls onto the speech and/or music module which is intercepted by a light-optical cell and converted into control currents in order to trigger the switching-on of the speech and/or music module. The speech and/or music recording in the speech and/or music module can be reproduced continuously or periodically, whereby adjusting possibilities are also provided in order to reproduce acoustically, for example in bigger intervalls, the speech and/or music recording when the toilet lid and/or seat panel is opened, whereas when closing the toilet lid, the urinal bowl lid and/or the seat panel the emitting of the speech and/or music recording is desactivated, since—when the toilet lid and/or the seat panel is closed—an ocean of light can be incident onto the light-optical speech and/or music module. The speech and/or music module can also contain speech and/or music recordings of any type such as, for example funny texts, advertising information, advertising spots or the like.

The speech and/or music module can be provided with the most different speech and/or music recordings in order to remind the user of a toilet to leave clean the toilet and the toilet rooms and to close the toilet lid before leaving the toilet room. The corresponding speech and/or music recording can be preprogrammed in the speech and/or music module. However, it is also possible by using a recording and reproducing device to enter respectively desired reminders and warnings in order to be then able to reproduce this speech or music recording in the respectively necessary case. With the toilet configured according to the invention, it is possible to remind toilet or urinal bowl users to leave clean toilet rooms and toilets, whereby no supplementary person is necessary any longer for this reminder and warning. The warning plates which are otherwise often overlooked in toilet rooms are no longer necessary. Furthermore, such reminders and warnings can be related to advertising information, advertising spots or the like, whereby a music accompaniment is also possible.

The configuration and arrangement of the device containing the speech and/or music module on the toilet is particularly advantageous. Due to the external arrangement of this device, the speech and/or music module is not subject to any splash water and dirt accumulation. Moreover, the device can be easily cleaned and kept clean hygienically. Since the casing of the device is connected with the speech and/or music module over a web-type support with one of the movable parts of the toilet, it is possible to carry out the fixing of the device for example between the toilet lid and the seat panel or between the seat panel and the peripheral toilet lid edge. Advantageous configurations of the invention are characterized in the subclaims.

According to an embodiment according to the invention, the casing with the speech and/or music module is placed by means of a support besides the seat panel and/or the toilet lid, the support being configured as a flat made of a metallic material or a plastic, whereby the flat bears at is one free end the casing with the speech and/or music module and is placed fixed or removable with its other end on the wall face of the seat panel and/or of the toilet lid which is turned to the toilet bowl. The removable fixation has the advantage that the device with the speech and/or music module can be removed without any effort for cleaning. The support for the device with the speech and/or music module has a lower thickness which is dimensioned so that the support can be placed between the toilet lid and the seat panel or the seat panel and the peripheral toilet lid edge without substantially increasing the intermediate space between the toilet lid and the seat panel or between the seat panel and the peripheral toilet lid edge.

According to a further embodiment, for a toilet configured in a way known per se, the programmable or preprogrammed speech module with a speech recording is placed fixed or removable on the inner wall face of the toilet lid which is turned to the inner space of the toilet bowl and/or on the seat panel by means of its casing which is connected with a mechanically or light-optically controlled on-off switch in such a way that the operation of the speech module by reproducing the speech recording is released when lifting the toilet lid and/or seat panel of a toilet. As a further embodiment, a toilet lid and/or a seat panel is provided with a speech module integrated into these parts of the toilet. An arrangement of the speech module on the inner wall face of the toilet bowl is also possible.

### BRIEF DESCRIPTION OF THE DRAWINGS

Embodiments of the invention will be explained in more detail below with reference to the attached drawings.

FIG. 1 is a graphical view of a toilet with an opened toilet lid and with two different external arrangements of a device with a speech and/or music module on the movable toilet parts.

FIG. 2 is a vertical longitudinal section through a toilet lid with removed toilet lid and with a device with the speech and/or music module fixed and held externally on the toilet seat.

FIG. 3 is a top view of a toilet with removed lid and laterally fixed speech and/or music module.

FIG. 4 is a vertical cross-section of a toilet bowl with a devic with the speech and/or music module fixed externally below the toilet lid.

FIG. 5 is a graphical view of a toilet with opened toilet lid and a speech and/or music module placed thereon.

FIG. 6 is a vertical longitudinal section through a toilet bowl with a speech and/or music module arranged on the toilet seat.

FIG. 7 is a top view of the toilet bowl according to FIG. 6.

FIG. 8 is a vertical cross section of a toilet bowl with a speech and/or music module placed below the toilet seat.

FIG. 9 is a vertical cross section through a section of the toilet lid with a speech and/or music module placed on its inner wall face.

FIG. 10 is a vertical cross section through a section of the toilet lid with a speech and/or music module placed in a recess in the toilet lid.

FIG. 11 is a vertical cross section through a toilet bowl with a support hung on the bowl edge between the toilet lid and the bowl edge for a container receiging a cleaning means and/or odor eliminating means with a moisture-proof speech and/or music module placed thereon.

FIG. 12 is a graphical view of an urinal bowl which can be closed with a lid for a wall fixation with a speech and/or music module fixed on the lid part.

FIG. 13 is a graphical view of a device which can be fixed to one of the movable parts of the toilet with the speech and/or music module.

FIG. 14 is a graphical front view of a device with the speech and/or music module.

FIG. 15 is a rear view of the device with the speech and/or music module.

FIG. 16 is a further rear view of the device with the speech and/or music module.

FIG. 17 is a rear view of the device with the speech and/or music module with removed rear wall.

### DETAILED DESCRIPTION OF THE PREFERRED EMBODIMENT

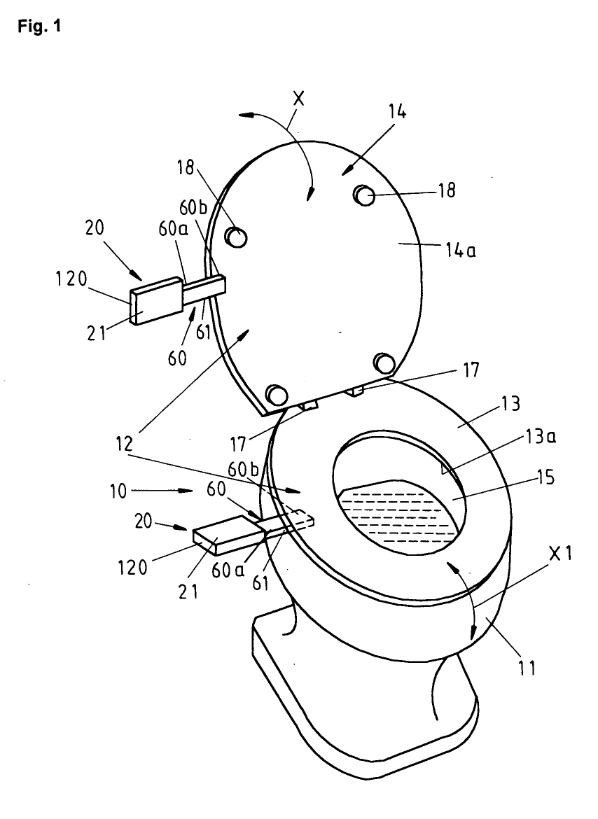

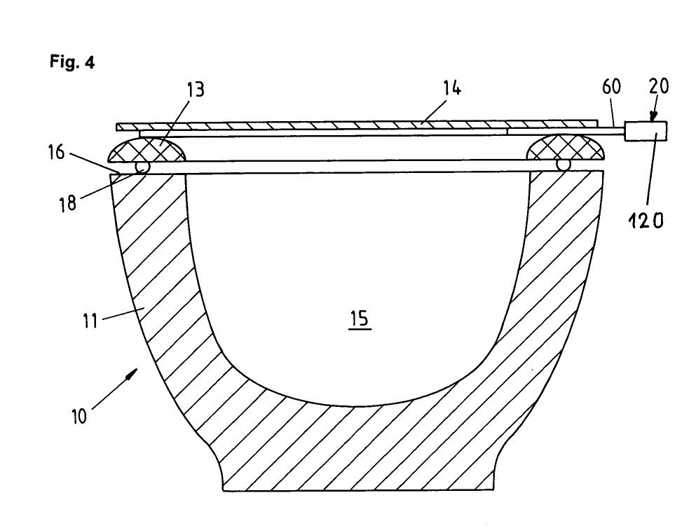

According to FIG. 1, the toilet 10 consists of a toilet bowl 11 and a toilet seat 12 which is formed by a seat panel 13 and a toilet lid 14, whereby the latter are connected with each other over swivelling hinges 17 in such a way that the seat panel 13 and the toilet lid 14 are swivellable separately from each other. The inner wall face of the toilet lid 14 which is swivellable in direction of the arrow X is indicated by 14a. The seat panel 13 which is also swivellable in direction of the arrow X1 independently of the toilet lid 14, rests on the peripheral toilet bowl edge 16, preferably with intercalated nub-type distance pieces 18 made of a resilient material (FIG. 4). The inner space of the toilet bowl 11 is indicated by 15.

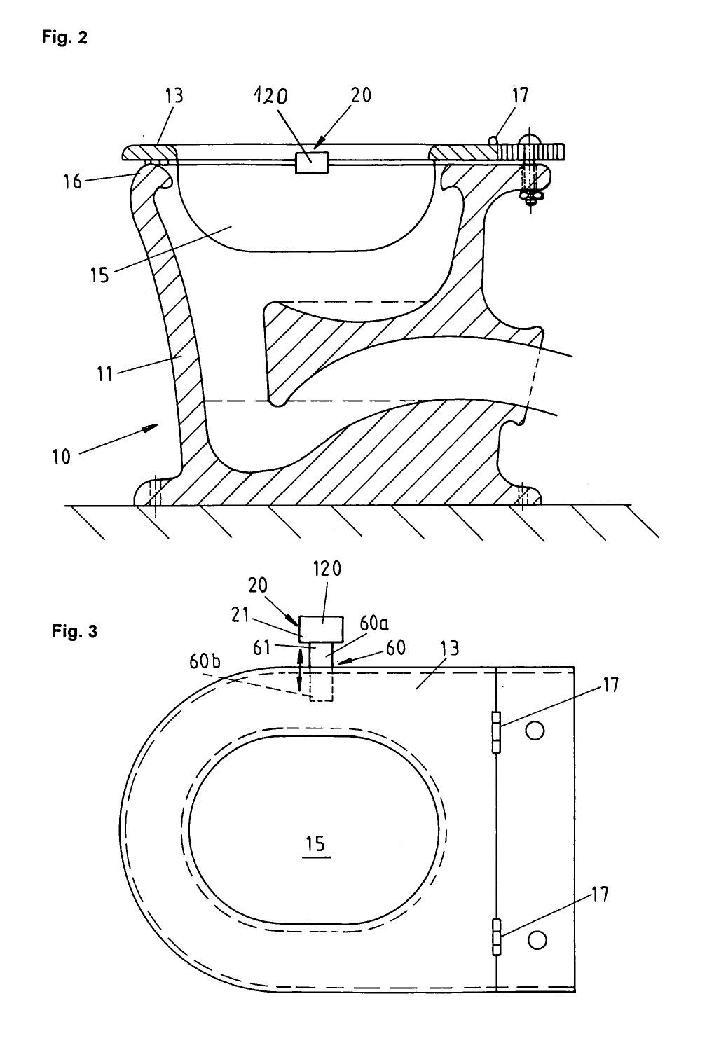

A device 20 is placed on the movable parts 13 and 14 of the toilet 10 or on only one of the two movable parts, this device consisting of a casing 21 in which a programmable or preprogrammed speech and/or music module 120 is placed (FIGS. 1, 5 and 9). This speech and/or music module 120 is provided with a corresponding speech and/or music recording and is fixed with its casing 21 by means of a support 60 to one of the movable parts 13, 14 of the toilet 10 (FIG. 1 to 4).

This speech and/or music module 120 configured in a manner known per se is connected with a mechanically or light-optically controlled on-off switch so that, when lifting the toilet lid 14 and/or the seat panel 13, the operation of the speech and/or music module is released by reproducing the speech and/or music recording. The speech and/or music module 120 is placed in the casing 21 which receives a source of current, preferably a battery 22. Moreover, the speech and/or music module 120 comprises a loudspeaker indicated by 23 or a microphone-loudspeaker unit 24 for recording and reproducing, whereby the on-off switching for the operation of the speech and/or music module ensues either over a mechanical control such as for example a lever, or over a light-optical cell/sensor 25 which is active with incident light and releases control currents for the operation of the speech and/or music module (FIG. 13).

The control, i.e. the switching on and off of the speech and/or music module 120 can ensue for example over a light-optical cell/sensor 25. The placing of the device 20 with the speech and/or music module 120 on one of the movable toilet parts 13, 14 is made in such a way that, the toilet lid 14 being opened, the light-optical device such as the photocell or the like is hit by light, whereby the photocurrents generated in this way are used for control purposes for the speech and/or music module in order to release the speech and/or music recording reproduction. When the toilet lid 14 is closed, the speech and/or music module 120 is not hit by light so that there does not happen any operation of the speech and/or music recording reproduction device. Preferably, the light-optical cell/sensor 25 is then placed on the support 60 for the device 20 in such a way that, when lifting the toilet lid 14 or the seat panel 13, the sensor is hit by light, whereas when closing the toilet lid 14 or the seat panel 13 the sensor is covered in such a way that no action of light onto the sensor is possible. To this purpose, the light-optical effect or sensor is placed between the toilet lid 14 and the seat panel 13 or between the seat panel 13 and the peripheral bowl edge so that the light control for the light-optical device or the sensor 25 is carried out over the position of the toilet lid 14 or of the seat panel 13. The light-optical device such as the photocell or the sensor 25 is then connected with the device 20 over corresponding current feeders in the support 60, whereby the support 60 can also receive devices of the speech and/or music module such as for example batteries or loudspeakers in its part lying outside the toilet.

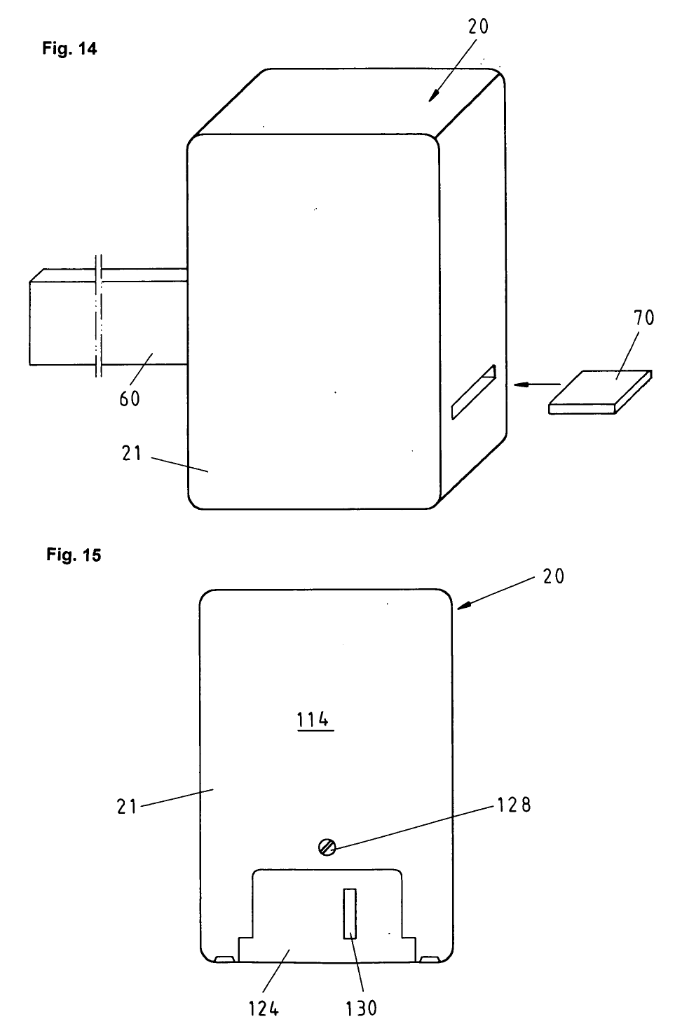

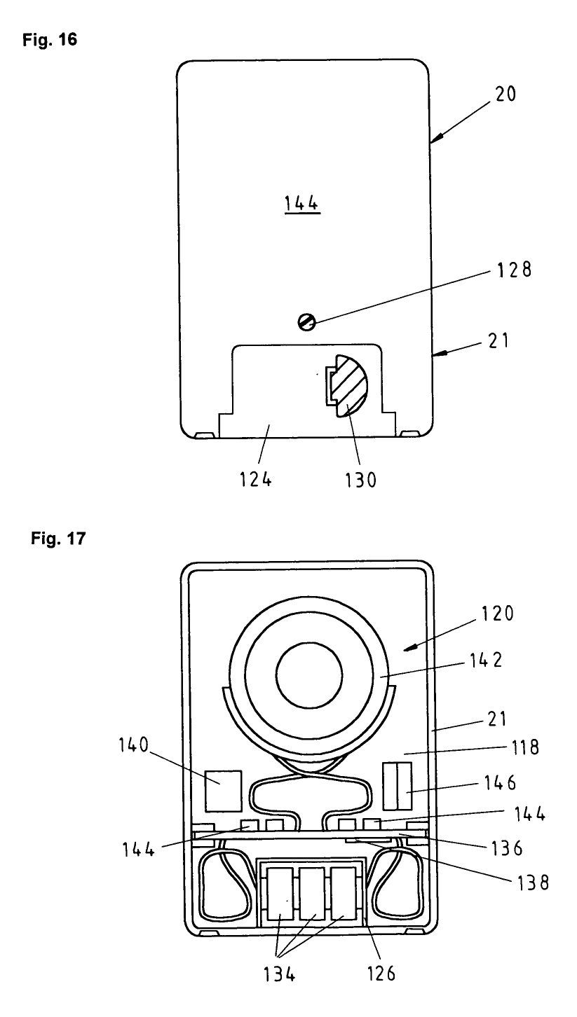

A further embodiment of a device 20 with a speech and/or music module 120 is represented in the FIGS. 14 to 17. This device 20 also comprises a casing 21 with a front part 112 and a rear lid 114 which together constitute the casing 21. The parts constituting the casing 21 can be connected with each other by means of screwed connections, however also by means of adhesive connections or other removable connections so that a dimensionally stable casing 21 is configured with the inner space 118.

Furthermore, a battery case lid 124 for closing a battery case 126 configured in one piece with the front part 112 is configured on the rear lid (FIG. 17). The battery case lid 124 is screwed by means of a screw 128 with the rear lid 114 so that it does not work loose unintended from the rear lid 114. The battery case lid 124 shows an opening 130 through which an isolating strip which is not represented in the drawing can be inserted gripping between corresponding batteries 134. In this way, a current supply of the device 20 is effectively interrupted during the transport and the storage and can be quickly and simply produced by simply pulling out the isolating strip. The device 20 can thus immediately be equipped with batteries 134 by manufacturing and mounting so that they do not have to be put in by an end user.

The batteries 134 serve for the current supply of a speech and/or music module 120 placed in the inner space 118 and thus completely encapsulated by the casing 110. This speech and music module comprises electronics 136 with a printed wiring board 136, a microprocessor 138 placed on the printed wiring board 136, a flip sensor 140 placed on the printed wiring board 136 and a loudspeaker 142 connected with the printed wiring board 136. The batteries 134 are connected with the printed wiring board 136 for the current supply of the electronics. The loudspeaker 142 is aligned on openings in the casing front wall so that a sound radiation of the loudspeaker 142 can emerge practically checkless from the inner space 14 of the casing. Furthermore, resistors 144 and capacitors 146 are placed for the outer wiring of the microprocessor with strip conductors configured correspondingly on the printed wiring board.

The device 20 represented in the FIGS. 14 to 17 can be fixed to the movable parts 13, 14 of the toilet 10, whereby the flip sensor 140 activates the electronics, when the toilet lid 14 and/or the seat panel 13 is tilted up.

Thereupon, the microprocessor 138 activates for example a spoken message indicating that a use of the toilet without toilet seat is not wished because of the soiling of the environment of the toilet caused hereby. The aim is to bring the toilet user to use the toilet sitting and with the toilet seat hinged down.

As FIG. 1 shows, the device 20 with the speech and/or music module 120 is placed externally by means of a support 60 on at least one of the movable parts 13, 14 of the toilet 10, namely in such a way that the casing 21 with the speech and/or music module rests laterally and outside the toilet (FIG. 3 and FIG. 4). The fixing of the support 60 is made on the inner wall face 14a of the toilet lid 14 or on the inner wall face 13a of the seat panel 13, whereby preferably the length of the support 60 is dimensioned in such a way that the casing 21 with the speech and/or music module comes to rest laterally on the toilet. The speech and/or music module 120 in the casing 20 is provided with a speech and/or music recording, whereby the speech and/or music module is programmable or can be preprogrammed, whereby it is also possible to insert a chip card with a microprocessor control (FIG. 14) containing the speech and/or music information.

The casing 21 with the speech and/or music module 120 is placed by means of the support 60 besides the seat panel 13 and/or the toilet lid 14, the support 60 being configured as a flat 61 made of a metallic material or of a plastic. The flat 61 carries on its free end 61a the casing 21 with the speech and/or music module 120, whereby the flat 61 can be connected removable or fixed with the casing 21. With its other end 61b, the flat 61 is placed removable or fixed on the wall face of the seat panel 13 and/of the toilet lid 14 which is turned to the toilet bowl (FIG. 1). The flat-type support 60 can be for example removably fixed by means of an self-adhesive band or of a Velcro fastener on the lower side of the seat panel 13 and/or of the toilet lid 14. A glued joint can be used for example for a fixed connection of the flat-type support 60 on one of the movable parts 13, 14 of the toilet 10.

The flat 61 of the support 60 is configured lengthwise adjustable. For this purpose, the flat 61 is configured for example telescopic and can be adapted to the respective placing requirements and wishes by varying the length.

The support 60 shows a lower thickness which is dimensioned so that the support can be placed between the toilet lid 14 and the seat panel 13 or between the seat panel 13 and the peripheral edge 16 of the toilet bowl 11 without considerably increasing the intermediate space between the toilet lid 14 and the seat panel 13 or between the seat panel 13 and the peripheral toilet bowl edge 16.

The flat 61 of the support 60 shows preferably a rectangular cross-sectional form. The surfaces of the support 60 and/or also of the casing 21 with the speech and/or music module 120 which are thus created can be configured as advertising spaces. However, the flat 61 of the support 60 can also have another geometrical cross-sectional form. It is essential that the flat 61 is configured as a tongue in its fixing area on the toilet lid 14 or on the seat panel 16 in order to have a lower thickness, whereby it is necessary for manufacturing the flat 61 to use materials which have a high inherent rigidity.

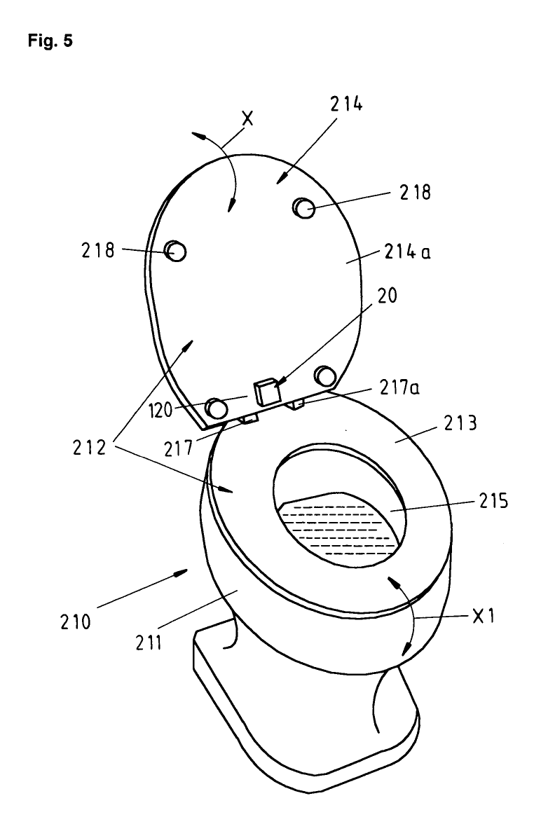

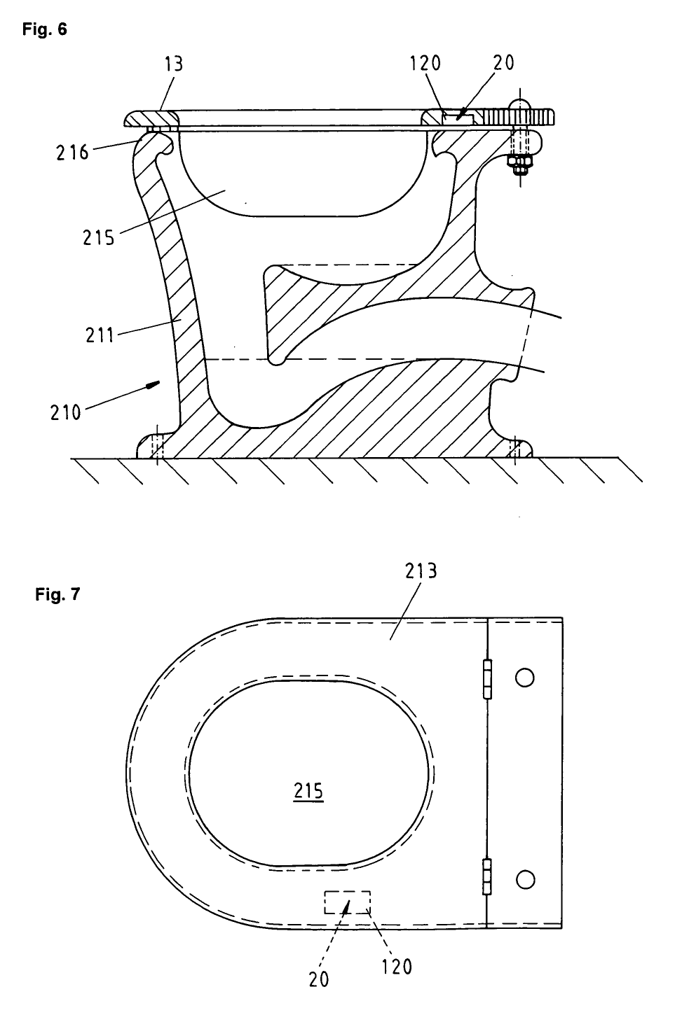

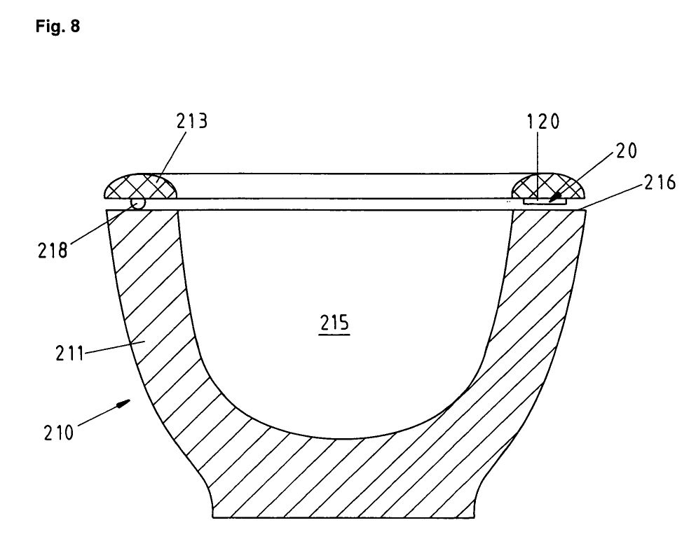

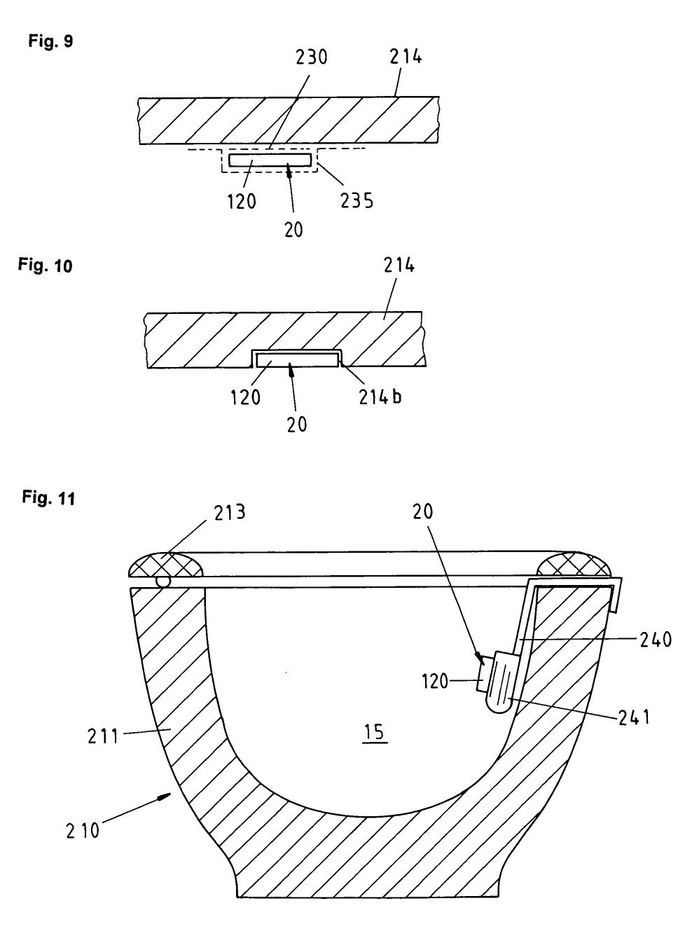

For the embodiment according to FIG. 5, the toilet 210 is configured in accordance with the toilet 10 and consists of a toilet bowl 211 and a toilet seat 212 which is formed by a seat panel 213 and a toilet lid 214, whereby the latter are connected with each other over swivelling hinges 217. The inner wall face of the toilet lid 214 which is swivellable in direction of the arrow X is indicated by 214a. The seat panel 213 which is also swivellable in direction of the arrow X1 independently of the toilet lid 214, rests on the peripheral toilet bowl edge 216, namely preferably with intercalated nub-type distance pieces 218 made of a resilient material (FIG. 8). The inner space of the toilet bowl 11 is indicated by 215. For the embodiment shown in FIGS. 6 and 7 as well as in FIGS. 8 and 11, only the seat panel 213 of the toilet seat 212 is represented. For these embodiments, the toilet lid 214 is removed.

A device 20 with a programmable or preprogrammed speech and/or music module 120 with a speech recording is placed on the inner wall face 214a of the toilet 214 lid which is turned to the inner space 215 of the toilet bowl 211 and/or on the seat panel 213, the fixing of the speech and/or music module 120 being carried out by means of its casing as described above. This speech and/or music module 120 is connected with a mechanically or light-optically controlled on-off switch in such a way that the operation of the speech and/or music module 120 by reproducing the speech and/or music recording is released when lifting the toilet lid 214 and/or seat panel 213.

The speech and/or music module 120 is placed with its casing according to a first embodiment on the inner wall face 214a of the toilet lid 214, namely preferably adjacent to the articulation area of the toilet lid 214 and of the seat panel 213 (FIG. 5). When the toilet lid 214 is opened, the light-optical device such as a photocell or the like is hit by light. The generated photocurrents are then used for control purposes for the speech and/or music module 120 in order to trigger the speech and/or music recording reproduction. When the toilet lid 214 is closed, the speech and/or music module 120 is not hit by light so that an activation of the speech and/or music recording reproducing device does not take place either.

The fixing of the speech module 20 with its casing on the inner wall face 214a of the toilet lid 214 is carried out by means of a self-adhesive coating 230 (FIG. 9). For the embodiment shown in FIG. 10, the toilet lid 214 is provided on its inner wall face 214a with a recess 214b for receiving the casing of the speech and/or music module 120 which is held in the recess 214b by press-fitting, by means of a glued joint or of another appropriate mechanical connection. After having inserted the speech and/or music module 120 into the recess 214b, the recess can be recovered by a plastic foil so that the speech and/or music module 120 is protected against water and moisture.

For the embodiment for which the speech and/or music module 120 is set with its casing onto the inner wall face 214a of the toilet lid 214, the speech and/or music module 120 can also be covered moisture-proof and splash-proof by means of a foil-type cover 235 (FIG. 9).

However, according to a further embodiment, it is also possible to place the speech and/or music module 120 on the seat panel 213 (FIGS. 6 and 7). The placing of the speech and/or music module 120 is then carried out in the way that, when the reproducing device for the speech recording is not activated, no light falls onto the light-optical device of the speech and/or music module 120 when the seat panel 213 shows the hinged down position shown in FIGS. 6 and 7, whereby a placing of the speech and/or music module 120 can however also be in the upper peripheral edge area of the seat panel 213, when the seat panel 213 is connected with a toilet lid 214 which covers then, in hinged down condition, the speech and/or music module 120 and its light-optical device. The placing of the speech and/or music module 120 on the seat panel is such that the proper seat surface is not affected in any way.

If the switching on and off of the speech module 20 is made by means of a mechanical device which is not represented in the drawing, for example by means of a control lever, the placing of the speech and/or music module 120 on the toilet lid 224 and/or on the seat panel is such that this control lever is in the swivelling area of the toilet lid 214 and/or of the seat panel 213 so that, when the toilet lid 214 and/or the seat panel 213 is closed, the control lever is introduced into the casing 221 of the speech module 20 and locks the operation of the reproducing device for the speech and/or music recording, while when opening the toilet lid 214 and/or the seat panel 213 the control lever is released so that an operation of the reproducing device of the speech and/or music recording is possible.

FIG. 11 shows a further advantageous embodiment. Here, the speech and/or music module 120 is placed with its casing on a receiver hung in the inner space 215 of the toilet bowl 211 which serves for receiving a cleaning agent and/or a bad smell removing agent or another agent. This receiver 214 is connected with a strap-type support 240 which is hung on the peripheral toilet bowl edge 216. In these cases in which these receivers are fixed in another manner to the toilet bowl 211, the speech and/or music module 120 is placed in a corresponding way. This embodiment makes it possible to make available to the buyer a product which is not only used for cleaning purposes or by annoyance caused by bad smell, but which furthermore also reproduces speech recordings. The speech and/or music module 120 can also be placed in the receiver 241. Receivers without any cleaning means and/or without a bad smell removing agent can also be used.

The speech and/or music module 120 is connected fixed or removable on the toilet lid 214 and/or on the seat panel 213 ; an integration of the speech and/or music module 120 into the toilet lid 214 and/or into the seat panel 213 is also possible. Furthermore, the speech and/or music module 120 can be placed fixed or removable on the inner wall face of the toilet lid 211, for example by means of glued joints or of mechanical connecting means, whereby the speech and/or music module 120 is placed moisture and splash proof.

It is also possible to place the speech and/or music module 120 by means of a support not represented in the drawing in the inner space or on the inner wall face of the toilet bowl 211, this support being then also hung on the peripheral toilet bowl edge 216.

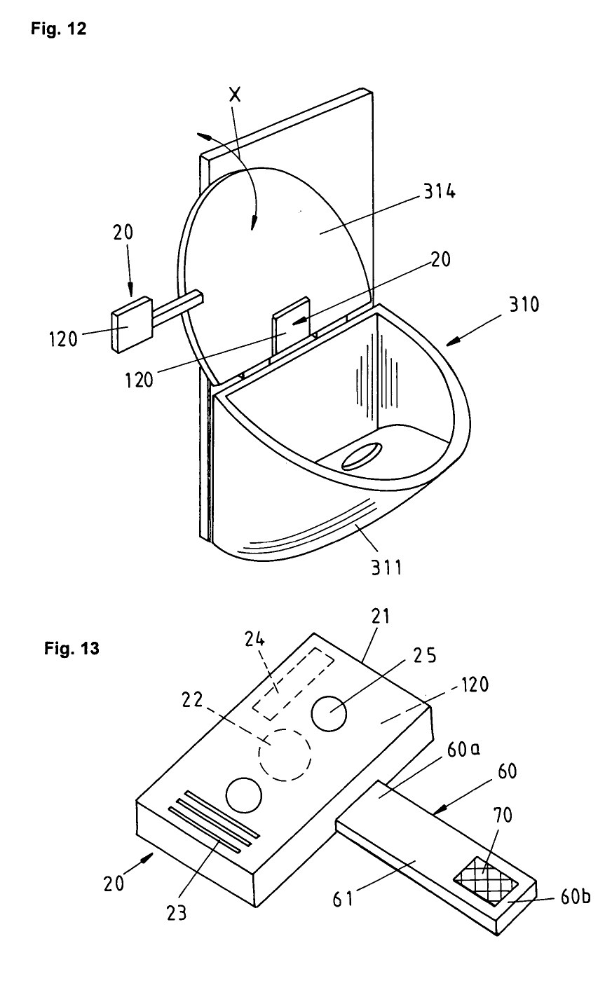

FIG. 12 shows an urinal bowl 311 which can be fixed to a vertical wall which can be closed by means of a lid part 314 swivellable in direction of the arrow X. The lid part 314 is provided with a speech and/or a music module 120 which can be fixed directly to the lid part 314 or which is held on the side of the lid part on the lid part.

1. A toilet consisting of a toilet bowl with a toilet seat made of a swivellable seat panel and a swivellable toilet lid as well as a wall-hung urinal which can be closed by means of a lid,
characterized in
that a casing (21) with a device (20) for emitting acoustical speech and/or music information is placed fixed or removable by means of a support (60) to at least one of the movable parts (12, 213, 14, 214, 314) of the toilet (10, 210) or of the wall-hung urinal (300) externally or internally, the casing comprising a programmable or preprogrammed speech and/or music module (120) or a chip card (70) containing the speech and/or music information with a microprocessor control, whereby the device (20) is connected with a mechanically or light-optically controlled on-off switch or a motion detector in such a way that, when lifting the toilet lid (14) and/or the seat panel (13) and/or the urinal bowl lid (314), the putting in and out of action of the speech and/or music module (120) is released by the reproduction of the speech and/or music recording.

2. A toilet according to claim 1,
characterized in
that the device for emitting acoustical speech and/or music information shows at least one loudspeaker (23), a source of current (22) and electronics for generating electrical signals for the loudspeaker.

3. A toilet according to one of the claims 1 or 2,
characterized in
that the electronics comprise at least one sensor which is configured in such a manner that it detects a motion state and/or an ambiance condition of the movable toilet parts (13, 14, 213, 214, 314) and activates the electronics for emitting the speech and/or music information in dependence of the detected state or of the detected ambiance condition.

4. A toilet according to one of the claims 1 to 3,
characterized in
that the sensor is a flip sensor which detects as a state a swivelling movement of one of the movable toilet parts (13, 14, 213, 214, 314), a light barrier, an infrared detector, a motion detector, a mechanical sensor, a touch sensor and/or an ultrasonic sensor, wherebei a switch which can be controlled by short-term acting heat, gestures, finger or pressure can be used.

5. A toilet according to one of the claims 1 to 4,
characterized in
that the electronics comprise a microprocessor (138) which is configured in such a manner that a speech and/or music information can be alternatively changed.

6. A toilet according to one of the claims 1 to 5,
characterized in
that the electronics comprise a printed wiring board (136), a microprocessor (138) placed on the printed wiring board (136), a flip sensor (140) placed on the printed wiring board (136), a loudspeaker (142) connected with the printed wiring board (136) and a current supply (134) connected with the printed wiring board (136).

7. A toilet according to one of the claims 1 to 6,
characterized in
that the device (20) or only the printed wiring board (electronics) for emitting acoustical speech and/or music information is placed fixed or removable on the support (60) and only the speech chip/music chip or microchip on the printed wiring board/device is replaceable (for example by a plug-in contact) in order to reprogramm or to respeak the speech chip/music chip/microchip.

8. A toilet according to one of the claims 1 to 7,
characterized in
that the device (20) with the speech and/or music module (120) is placed in the inner space of the casing (21) with the support (60), the device being configured in the casing as electronics with a sensor (140) which is configured in such a manner that it detects a motion state and/or an ambiance condition of the casing (21) and activates the electronics for emitting the speech and/or music information in dependence of the detected state or of the detected ambiance condition.

9. A toilet according to claim 8,
characterized in
that the sensor is a motion detector or a flip sensor (140) which detects a tilting movement or a swivelling movement of the casing (21) as a state.

10. A toilet according to any of the claims 1 to 9,
characterized in
that the complete speech and/or music module (120) or the complete electronics such as the microprocessor and/or chip or sensor or switch, current supply, wiring (printed wiring board) or the device is placed only on or by or in a flat smart card.

11. A toilet according to any of the claims 1 to 10,
characterized in
that the casing (21) with the speech and/or music module (120) is placed by means of the support (60) besides the seat panel (13, 213) and/or the toilet lid (14, 214) and/or the urinal bowl lid (314), whereby the support (60) is configured as a flat (61) made of a metallic material or of a plastic, whereby the flat (61) supports at its one free end (61a) the casing (21) with the speech and/or music module (120) and is placed fixed or removable with its other free end (81b) on the wall face of the seat panel (13) and/or of the toilet lid (14) which is turned to the toilet bowl (11).

12. A toilet according to any of the claims 1 to 11,
characterized in
that the flat-type support (60) is removably fixed to the lower side of the seat panel (13) and/or of the toilet lid (14) by means of a self-adhesive band (70) or of a Velcro-type fastener.

13. A toilet according to any of the claims 1 to 11,
characterized in
that the flat-type support (60) is placed fixed to the lower side of the seat panel (13) and/or of the toilet lid (14) by means of a glued connection.

14. A toilet according to any of the claims 1 to 13,
characterized in
that the flat (61) of the support is configured adjustable lengthwise.

15. A toilet according to any of the claims 1 to 14,
characterized in
that the support (60) shows a lower thickness which is dimensioned so that the support (60) can be placed between the toilet lid (14) and the seat panel (13) or between the seat panel (13) and the peripheral toilet bowl edge (16) without considerably increasing the intermediate space between the toilet lid (14) and the seat panel (13) or between the seat panel (13) and the peripheral toilet bowl edge (16).

16. A toilet according to any of the claims 1 to 15,
characterized in
that the faces of the support (60) and/or of the casing (21) are configured as advertising spaces.

17. A toilet according to any of the claims 1 to 10,
characterized in
that a device (20) with a programmable or a preprogrammed speech and/or music module (120) with a speech and/or music recording is placed by means of its casing on the inner wall face (214a) of the toilet lid (214) turned to the inner space (215) of the toilet bowl (211) and/or on the seat panel (213), this casing being connected with a mechanically or light-optically controlled on-off switch in such a way that, when lifting the toilet lid (214) and/or the seat panel (213), the putting in and out of action of the speech and/or music module (120) is released by the reproduction of the speech and/or music recording.

18. A toilet according to any of the claims 1 to 10 or 17,
characterized in
that the device (20) with the speech and/or music module (120) is integrated into the toilet lid (214) and/or into the lid part (314) of the urinal bowl (300).

19. A toilet according to any of the claims 1 to 10, 17 and 18,
characterized in
that the speech and/or music module (120) is fixed with its casing by means of a self-adhesive coating (230) to the inner wall face (214a) of the toilet lid (214; 314).

20. A toilet according to any of the claims 1 to 10, 17 to 19,
characterized in
that the toilet lid (214, 314) is provided on its inner wall face (214a) with a recess (214b) for receiving the casing with the speech and/or music module (120) which is held in the recess (214b) by press-fitting, by means of a glued joint or of another appropriate mechanical connection.

21. A toilet according to any of the claims 1 to 10, 17 to 20,
characterized in
that the casing of the speech and/or music module (120) fixed to the inner wall face (214a) of the toilet lid (214, 314) or to the seat panel (213) is covered moisture-proof and protected against splash water by means of a foil-type cover (235).

22. A toilet according to any of the claims 1 to 10, 17 to 21,
characterized in
that the speech and/or music module (120) with its casing is placed on one or in one receptacle or toilet cleaning means and/or bad smell removing agent receiver (241) hung in the inner space (215) of the toilet bowl (11) or urinal bowl (311).

23. A toilet according to any of the claims 1 to 10, 17 to 22,
characterized in
that the speech and/or music module (120) with its casing is placed moisture-proof and protected against splash water in the inner space of the bowl (211, 311) by means of a support held or hung on the peripheral toilet bowl edge (216) or urinal bowl edge.
